(19) United States
(12) Patent Application Publication
(10) Pub. No.: US 2006/0143277 A1
(43) Pub. Date: Jun. 29, 2006

(54) Method and system for distributing e-mail messages to recipients

(75) Inventors: Frederic Bauchot, Saint-Jeannet (FR); Francois-Xavier Drouet, La Gaude (FR); Gerard Marmigere, Drap (FR)

Correspondence Address: David Aker, 23 Southern Road, Hartsdale, NY, 10530, US

(73) Assignee: International Business Machines Corporation

(21) Appl. No.: 11/305,982

(22) Filed: Dec. 17, 2005

(30) Foreign Application Priority Data
Dec. 23, 2004 (EP) 04300945.5

(51) Int. Cl. G06F 15/16

(52) U.S. Cl. 709/206

(57) ABSTRACT

In a data processing system (100) supporting electronic mail (e-mail) messaging, a method, an apparatus and software for distributing an e-mail message from a sender mail user agent (315a) to recipients mail user agents (315b-315f), comprising: providing a remote directory (305) of recipients' contacts including recipients e-mail addresses, the remote directory being located remotely (310) with respect to the sender mail user agent; providing a mail transfer agent (330b) having an interface function (340) with said remote directory, the interface function being adapted to interact with the remote directory so as to perform queries and obtain in reply lists of recipients' e-mail addresses; including in an address field of the e-mail message a pseudo-address, the pseudo-address comprising an address of said mail transfer agent, and at least one directive for the interface function; upon reception of the e-mail message by the mail transfer agent, having the interface function translate the at least one directive into a corresponding query, submitting the query to the directory, and retrieve a list of recipients e-mail addresses; and propagating the e-mail message from the mail transfer agent to the recipients whose e-mail addresses are in the list.

### CROSS REFERENCE TO RELATED APPLICATION

This application is related to Attorney Docket No. FR920040054US1, also entitled, METHOD AND SYSTEM FOR DISTRIBUTING E-MAIL MESSAGES TO RECIPIENTS, by the same inventors, filed of even date herewith, and incorporated by reference herein.

### TECHNICAL FIELD

The present invention generally relates to the field of electronic data processing systems, and particularly to data processing systems networks (computer networks) supporting electronic messaging (electronic mail) systems.

### BACKGROUND ART

With the growth of computer networks, electronic mail (shortly referred to as e-mail) has become an extremely fast, economic, easy to use and thus popular interpersonal communication mean, for both private and professional purposes. In particular, thanks to the impressive diffusion of the Internet in the past decade, Internet e-mail nowadays provides a standard communication mechanism for millions of computer users.

By means of any one of the several, commercially available e-mail client software applications adapted to be executed on computers, such as IBM LotusNotes, Microsoft Outlook or Outlook Express, and Eudora, just to cite a few, composing and sending an e-mail message is a rather simple task, that involves specifying the e-mail address or addresses of one or more intended recipients of the message in one or more recipient address fields (the conventional “To”, “Cc” and “Bcc” fields) of a message composition dialog window on the computer's screen, editing if desired a message subject field, editing a message body and, possibly, attaching one or more files to the message.

Roughly speaking, an e-mail system is conventionally composed by two kinds of sub-systems, cooperating with each other.

The e-mail clients running on the data processing apparatuses (personal computers, workstations, personal digital assistants, smart mobile phones and the like) of users subscriber of the e-mail service and enabling them to handle (compose, send, receive, display) e-mail messages form a first type of sub-system, and are also referred to as Mail User Agents (MUAs).

A second type of sub-system includes so-called Mail Transport Agents (MTAs), that act as bridges between two or more MUAs, handling the distribution, i.e., the delivery and the reception of e-mail messages, and users' mailboxes, wherein the e-mail messages for the users are (at least temporarily) stored. Typically, an MTA includes a Simple Message Transfer Protocol (SMTP) server, handling the delivery and the reception of e-mail messages to and from other SMTP servers, and/or a Post Office Protocol (POP) server, e.g., a POP3 server, allowing the users to access the respective mailboxes from their data processing apparatuses via the MUAs. In particular, the MTAs are responsible to deliver the e-mail messages into proper mailboxes according to recipient addresses specified by the sender users upon compiling the messages: for example, if an e-mail message's recipient address is abc@aaa.com, where abc identifies the intended destination user's account name (or mailbox), whereas aaa.com is the address (the domain name) of the recipient user's MTA, then the MTA of the recipient user is responsible of delivering the message into the mailbox of the recipient user abc associated with the domain named aaa.com. In greater detail, the MTA of the sender receives from the sender user's MUA the e-mail message specifying as recipient the address abc@aaa.com, then it sends a request (so-called “MailX” request) to a Domain Name Server (DNS) for resolving the address and obtaining the IP address that corresponds to the domain name aaa.com of the destination user's MTA, and finally sends the message to that IP address (possibly through an intermediate MTA relay that is responsible to deliver the message to the intended destination MTA).

When delivering e-mail messages, MTAs operate according to a “store and forward” mechanism, which means that the messages are temporarily stored at the MTA until the MTA has an appropriate transmission channel available for forwarding them to the destination MTA(s).

Not rarely, users need to send e-mail messages to a plurality of recipients. Most e-mail client software products have tools facilitating the compilation of the recipient address fields of e-mail messages; such tools include for example address book utilities that allow creating user-defined local address books wherein the user can save e-mail addresses for subsequent retrieval. These tools also allow the users creating mailing lists or groups of recipients, including two or more recipients' e-mail addresses, so that when the users desire to send an e-mail message to the recipients of a given mailing list, they do not need to individually select from the address book (or even manually input) the address of every single recipient. In addition to local address books, MUAs may enable access to a shared, remote directory, such as the corporate directory of an enterprise's workforce, possibly by exploiting the services of a directory server.

According to the SMTP protocol, a sender MTA establishes a connection with a recipient MTA for submitting messages addressed to the intended recipients. During this connection, the two MTAs exchange information, that may be stored in a log file. In particular, the sender MTA establishes one connection with a specific recipient MTA in respect of each specific domain name as specified in the recipients addresses list, and in a same connection one message could be submitted to the corresponding recipient MTA, which message is addressed to several recipients sharing the same domain name.

### SUMMARY OF THE INVENTION

The Applicant has observed that the known way of managing the distribution of e-mail messages to a multiplicity of intended recipients is not particularly efficient.

Firstly, the message sender has to select all the different addresses of the intended recipients; even if this action is simplified by the use of address book or directory utilities local to the sender's MUA, the sender has nevertheless to create and manage the desired groups or mail distribution lists.

Secondly, the delivery of a same message to different recipients often involves the sending, by the sender (or a relay) MTA of several different identical copies of the same message, each copy being sent to a specific destination MTA for one (or more) recipients sharing the same domain name. This necessity to set up different connections with different MTAs, and the consequent increase in the exchanged data traffic, is, in the Applicant's opinion, rather ineffective.

A further problem that the Applicant has observed concerns the possibility offered to users of exploiting the more and more popular remote, shared directories, for example availing themselves of the services provided by a directory server.

In order to exploit the services provided by a directory server for retrieving e-mail addresses, the generic user should know the name of the remote directory, and be sure that the entries in the directory correspond to the desired, target list of recipients. Alternatively, if remote access to directory is allowed by the directory administrator, the user might download the whole remote directory to his/her data processing apparatus, and then use the downloaded directory just as if it was a local address book. This is however not very smart, and moreover the remote directory is constantly updated (by the directory manager), so the local replica might soon become obsolete.

In view of the state of the art outlined above, it has been an object of the present invention to provide a method and system for distributing e-mail messages to a plurality of recipients that is not affected by the drawbacks and limitations, and is more effective than the known methods.

In particular, it has been an object of the present invention to provide a method and system that allows benefiting of existing, shared remote directories.

According to a first aspect of the present invention, this and other objects have been attained by means of a method as set forth in the appended claim 1.

The method comprises: providing a remote directory of recipients' contacts including recipients e-mail addresses, the remote directory being located remotely with respect to the sender mail user agent; providing a mail transfer agent (330b) having an interface function with said remote directory, the interface function being adapted to interact with the remote directory so as to perform queries and obtain in reply lists of recipients' e-mail addresses; including in an address field of the e-mail message a pseudo-address, the pseudo-address comprising an address of said mail transfer agent, and at least one directive for the interface function.

Upon reception of the e-mail message by the mail transfer agent, the interface function translates the at least one directive into a corresponding query, submits the query to the directory, and retrieves a list of recipients e-mail addresses.

The e-mail message is propagated from the mail transfer agent to the recipients whose e-mail addresses are in the list.

Another aspect of the present invention relates to a data processing systems adapted to implement the above-mentioned method, and to software for implementing the method.

Other aspects of the present invention relates to computer program codes and computer program code products.

### BRIEF DESCRIPTION OF THE DRAWINGS

The features and advantages of the present invention will be made apparent by the following detailed description of an embodiment thereof, provided merely by way of non-limitative example, which will be made in conjunction with the attached drawing sheets, wherein:

FIG. 1 is a schematic, very simplified view of a computer network supporting an e-mail service;

FIG. 2 schematically shows, in terms of functional blocks, the main components of a generic computer of the network of FIG. 1;

FIG. 3 shows, in terms of functional blocks, the main components of an e-mail delivery system according to an embodiment of the present invention;

FIG. 4 is a table showing standard LDAP attributes of X.500 directiry entries corresponding to contacts; and

FIG. 5A-5B together are a schematic flowchart illustrating some of the steps of a method according to an embodiment of the present invention.

### DETAILED DESCRIPTION OF THE PREFERRED EMBODIMENT

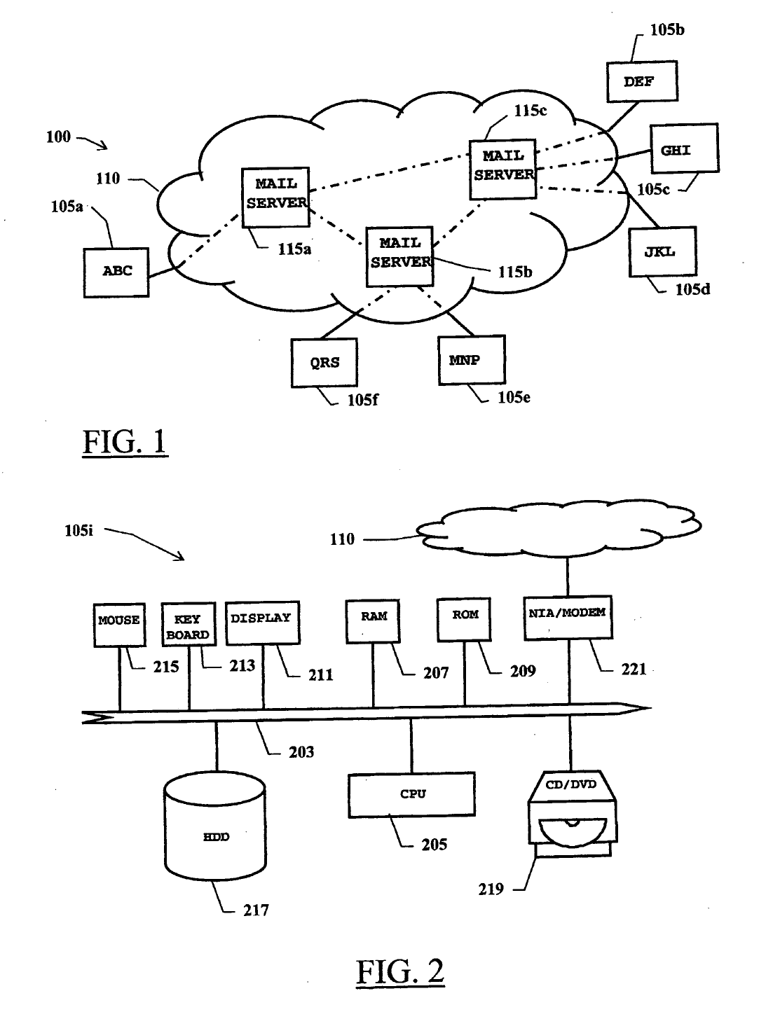

With reference to the drawings, in FIG. 1 a distributed electronic data processing system or computer network 100 is shown very schematically. The computer network 100 can be for example a local area network (LAN), a metropolitan area network (MAN), a wide area network (WAN) or a network of networks such as the Internet, particularly but not limitatively an open network, and comprises a plurality of data processing apparatuses, e.g., Personal Computers (PCs), workstations, personal digital assistants, smart mobile phones or the like, such as the data processing apparatuses 105a-105f, which in the following of the present description, for the sake of conciseness, will be shortly referred to as computers. The computers 105a-105f are connected (through respective, suitable access points, not explicitly depicted) to a data communication infrastructure 110, so as to be interconnected/interconnectable to each other.

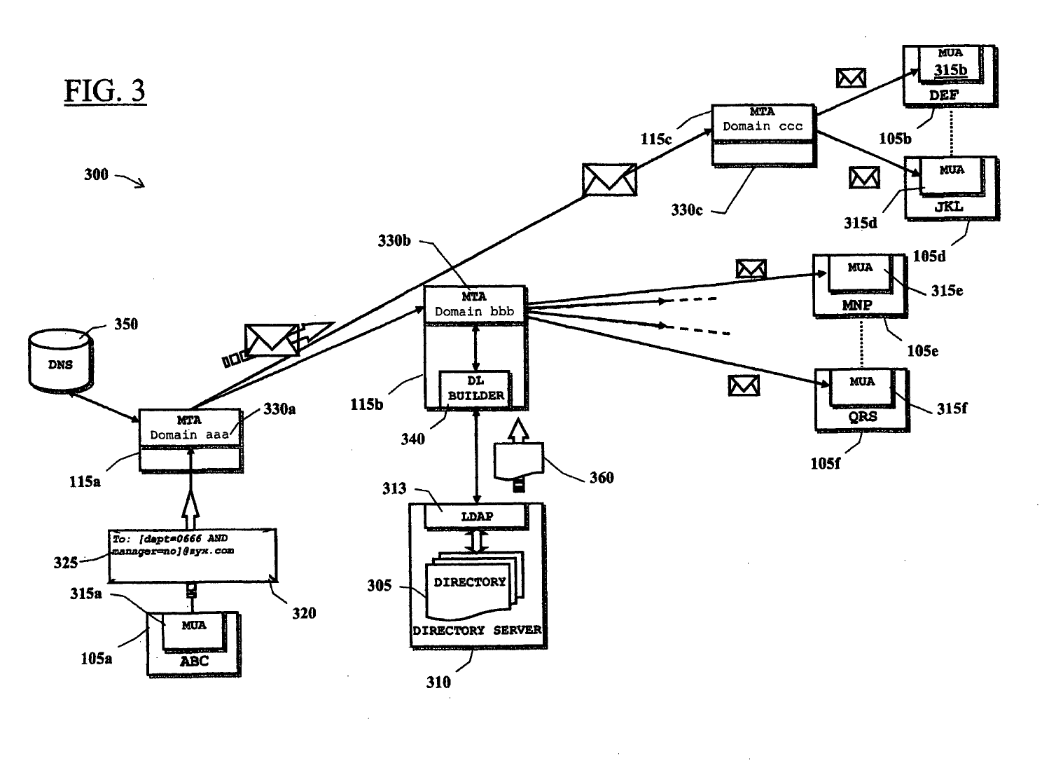

A generic computer 105i of the computer network 100 may in principle be represented in the way schematically shown in FIG. 2, with several functional units connected in parallel to a data communication bus 203 (for example a PCI bus). In particular, a Central Processing Unit (CPU) 205, typically comprising a microprocessor (possibly, a plurality of cooperating microprocessors), controls the operation of the computer 105i, a working memory 207, typically a RAM (Random Access Memory) is directly exploited by the CPU 205 for the execution of programs and for temporary storage of data, and a Read Only Memory (ROM) 209 is used for permanent storage of data, and stores for example a basic program for the bootstrap of the computer 105i. The computer 105i comprises several peripheral units, connected to the bus 203 by means of respective interfaces. Particularly, peripheral units that allow the interaction with a human user are provided, such as a display device 211 (for example a CRT, an LCD or a plasma monitor), a keyboard 213 and a pointing device 215 (for example a mouse). The computer 105i also includes peripheral units for local mass-storage of programs (operating system, application programs) and data, such as one or more magnetic Hard-Disk Drivers (HDD), globally indicated as 217, driving magnetic hard disks, a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards, a Universal Serial Bus (USB) adapter with one or more USB ports, printers and the like. The computer 105i is further equipped with a Network Interface Adapter (NIA) card 221 for the connection to the data communication network 110; alternatively (or in addition), the computer 105i may be connected to the data communication network 110 by means of a MODEM, not explicitly depicted in the drawing.

Any computer 105a, . . . , 105f in the computer network 100 has a structure generally similar to that depicted in FIG. 2, possibly properly scaled depending on the machine computing power.

Referring back to FIG. 1, the computer network 100 supports an e-mail service, enabling users of networked computers, such as the users ABC, DEF, GHI, JKL, MNP and QRS of the computers 105a-105f, to exchange e-mail messages over the network 100. As known in the art, each one of the users of the computers 105a-105f who is a subscriber to the e-mail service is identified by a unique e-mail address; a generic e-mail address takes the known, general form user@host.domain, where user is the user's account name (identifying the user's mailbox), @ is a separator, and host.domain is the domain name of the host data processing apparatus managing the user's mailbox. It is assumed and that users ABC, DEF, JKL, MNP and QRS of the computers 105a to 105f have respective e-mail addresses abc@aaa.com, def@ccc.com, jkl@ccc.com, mnp@bbb.com qrs@bbb.com. Generally speaking, the e-mail service is supported by the provision, within the computer network 100, of mail servers, like the mail servers 115a, 115b and 115c, which in particular manage the delivery of e-mail messages to the proper recipients.

As discussed in the introductory part of the present description, an e-mail system is conventionally composed by two kinds of sub-systems, cooperating with each other, namely Mail User Agents (MUAs), that are client software products running on the users' computers and enabling them to handle (compose, send, receive, display) e-mail messages, and Mail Transport Agents (MTAs), that act as bridges between two or more MUAs, handling the distribution, i.e., the delivery and the reception of e-mail messages, and users' mailboxes, wherein the e-mail messages for the users are (at least temporarily) stored. In particular, the MTAs are responsible to deliver the e-mail messages into proper mailboxes according to recipient addresses specified by the users upon compiling the messages.

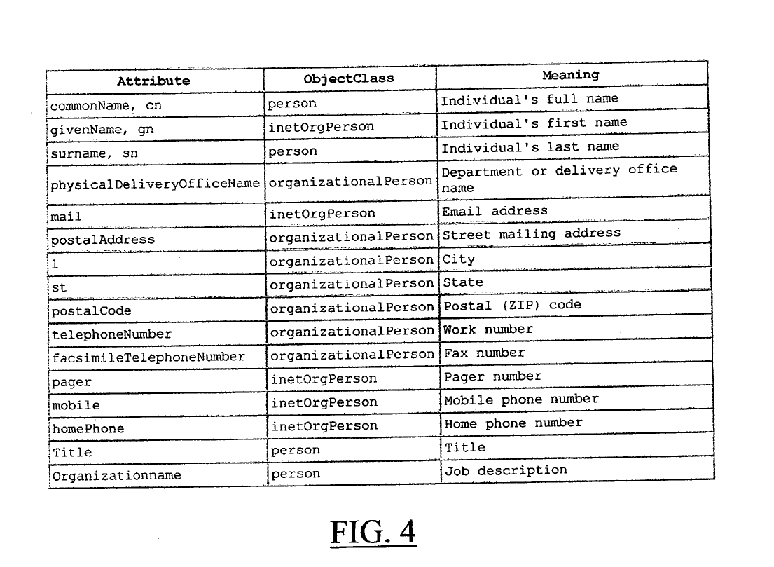

Schematically depicted in FIG. 3 are functional blocks representing the main components of an e-mail delivery system 300 according to an embodiment of the present invention. In the following it will be assumed that the user ABC of the computer 105a plays the role of an e-mail message sender, sending an e-mail message intended to be distributed to a plurality of recipient users, among which the users DEF, JKL, MNP, QRS of the computers 105b-105f.

It is also assumed that details of at least some of the intended recipients, particularly their e-mail addresses, are stored in a shared directory 305, remote from the computer 105a, and for example managed by a directory server 310, providing a directory service.

Directory services are per-se known in the art, and are becoming more and more popular in the information technology industry; roughly speaking, a directory service is a (computer network) service that provides a single, consistent database in which to store information about a computer network and network-based resources, such as users, servers, files, printers, shares, and the like, and which maps the names of network resources to their respective network addresses, thereby a user does not need to remember the physical address of a network resource. A directory server treats each network resource as an object, and information about a particular resource are stored in the directory as attributes of that object.

In particular, albeit this is not to be construed as a limitation of the present invention, the directory 305 and the directory server 310 comply with the ISO/ITU-T (CCITT) recommendation X.500, which defines a directory structure based on a Directory Information Tree (DIT), with standard objects (as defined in the recommendation X.520) describing, for example, the data relating to a person (for example, for a company employee, name, surname, office telephone and facsimile numbers, mobile phone number, department, position, location, e-mail address and so on). The X.500 recommendation also specifies the details of the protocol (Directory Access Protocol—DAP) to be adopted for accessing the directory. The DAP has been recognized to be too complex for several uses; a less complex, easier-to-use protocol for accessing X.500 directories is the Lightweight DAP (LDAP), which defines a relatively simple protocol for updating and searching directories. Accordingly, in an embodiment of the present invention the directory server 310 is for example an “LDAP server”, i.e., a directory server having a suitable LDAP interface 313 adapted to make the directory 305 accessible via the LDAP protocol (whereas the objects in the directory 305 are identified by X.500-compliant identifiers); the directory 305 can thus be referred to as an “LDAP directory”.

In greater detail, but without the pretension of completeness (being concepts which are per-se known in the art), an LDAP directory includes at least one entry, consisting of a collection of attributes; each attribute is univocally identified by a respective name (the “distinguished name”), and is assigned a type (a mnemonic string such as “cn” for common name, “gn” for given name, “sn” for surname, “mail” for the e-mail address) and one or more values that depend on the type.

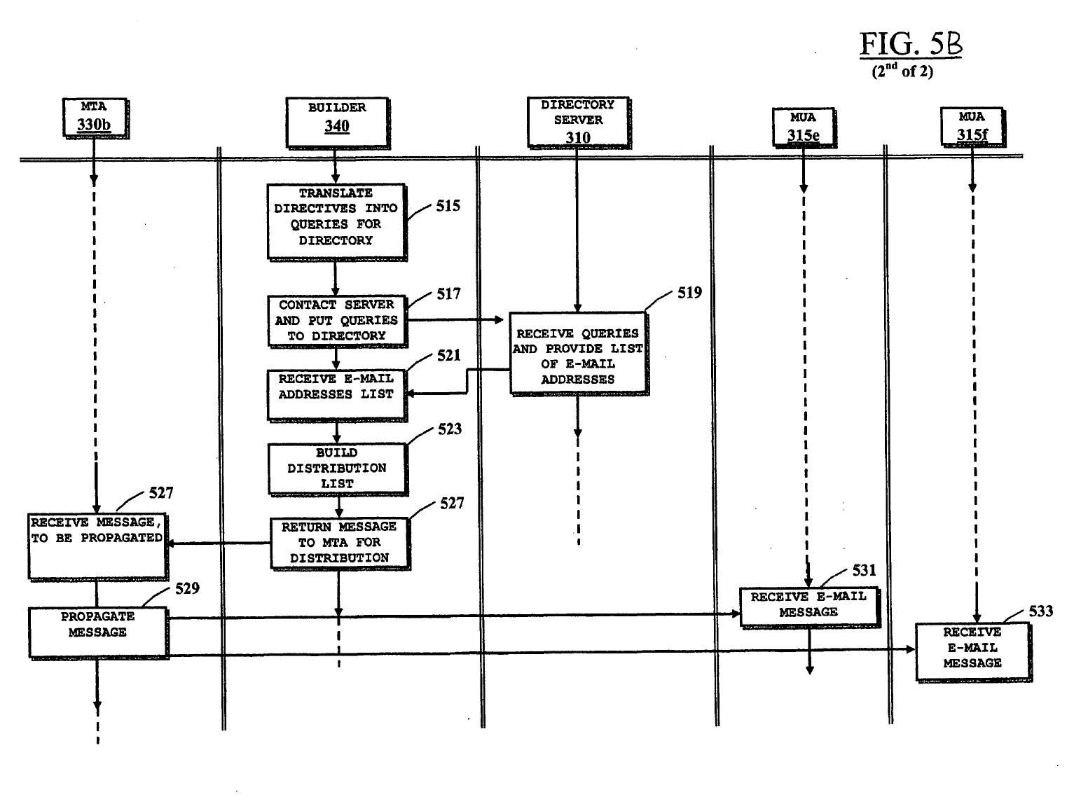

FIG. 5 provides, in terms of a self-explanatory table, a list of typical LDAP attributes of an LDAP directory of contact entries of persons forming the workforce of an organization, e.g., an enterprise, with the indication of the class of objects and the meaning in plain words.

LDAP directory entries are hierarchically structured so as to reflect, e.g., organizational boundaries

The advantages of LDAP reside in the fact that it has been designed to be a general-purpose, extensible directory, using an object-oriented, inheritance-based schema definition, which provides for easy extension to any reasonable use. There is a base schema as part of the LDAP specification, and there are other de facto standards for various services. LDAP is a simple protocol to implement and work with, particularly because LDAP is supported by most major programming languages, including C, Java, and Perl, and either is or will be supported by most major operating systems, including Solaris, GNU/Linux, Microsoft Windows, and Mac OS. Using data replication, it is possible to replicate all or part of an LDAP directory to physically separate locations, which allows for highly-available data and makes it possible to put the data as close as necessary to the client. Using referrals, data mastery of portions of the directory can be distributed across different LDAP servers, thus allowing portions of an enterprise or project to have control over necessary data while maintaining a single authority over each piece of data. So, although for the sake of simplicity it is herein assumed that the directory 305 is concentrated in one server 310, this is not a limitation, because the directory 305 might as well be distributed, spread through two or more different servers, and still be seen by users as a unique directory.

The LDAP specification states that LDAP clients can request the entire feature list and data schema from any LDAP server, thus allowing the client to vary its functionality according to that of the server, which should provide greater interoperability across different implementations and different versions of LDAP. LDAP uses UTF-8 for internal string representations, which allows LDAP to store and manipulate essentially any known language.

Security is another feature of the LDAP protocol. In particular, for secure access, LDAP supports Transport Layer Security (TLS), which can encrypt all communication between the client and server; for authentication, LDAP supports Simple Authentication and Security Layer (SASL), which allows the client and server to negotiate a reasonably secure authentication method. TLS and SASL provide encryption capabilities but not control over access and authentication. LDAP actually provides the ability to control all three aspects of AAA (Access, Authentication and Authorization) through Access Control Lists (ACLs). ACLs can be used to grant access based on many different factors. They can be used to force specific types of authentication, and once the client is fully authenticated as a valid user, ACLs are used to authorize the user.

Moreover, because LDAP is an open standard (maintained by the Internet Engineering Task Force—IETF), it can be used by any developers, companies, or administrators without fear of being tied to proprietary protocols or specific vendors, and allows the choice of implementation to be based on project details rather than interoperability concerns. LDAP can thus progress according to the needs of the people who use it, rather than a corporation concentrating on profits or market share.

Thanks to these (and other) features, LDAP is being more and more adopted.

Back to FIG. 3, in the computer 105a of the sender user ABC, an e-mail client software is assumed to be installed which, when executed, activates an MUA 315a that enables the user ABC managing (compose, send, receive, display) e-mail messages.

In particular, the MUA 315a may be any conventional, commercially available MUAs (e.g., Lotusnotes, Outlook, Outlook Express, Eudora), and includes a Graphical User Interface (GUI), enabling the user to interact with the MUA 315a through the computer's display device 211, the keyboard 213, the mouse 215; a message composer software module for composing messages, which interacts with the user via a message composition interface, typically a dialog box with fields that the user has to fill-in; a message formatter software module for formatting the message according to the syntax prescriptions of (a selected) one (out) of the known standards for formatting e-mail messages. Examples of such standards are the Request For Comments (RFC) 2822 (“Internet Message Format”) and the RFC 2045, RFC 2046 and RFC 2049 (Multifunction Internet Mail Extensions, shortly MIME); in particular, the RFC 2822 standard is aimed at specifying the format of text messages in ASCII code, while the MIME standard, which is substantially an extension of the RFC 2822 standard, also specifies the format for multimedia messages including sound, images, video.

Considering, for the sake of simplicity, the RFC 2822, this standard prescribes in particular that an e-mail message is a text string formed by a message header portion and a message body portion. The message body portion contains the message body, and is simply formed by lines of ASCII characters. The message header portion has a rigid format, and consists of several fields, some of which must be present in every e-mail message, some other being instead optional. Typically, the message header portion includes a field (“From” field) specifying the e-mail address of the message sender (originator address). One or more fields are provided for specifying the intended recipient or recipients of the message; in particular, a field (“To” field) specifies the e-mail address, or the list of e-mail addresses of the intended primary recipients; an optional field (“Cc” or carbon-copy field) specifies the e-mail address, or the list of e-mail addresses of recipients who, albeit not being the intended primary recipients, are intended to receive a (carbon) copy of the message, in addition to the primary recipients; another optional field (“Bcc” or blind carbon-copy field) specifies one or more e-mail addresses of recipients that are intended to receive the message in copy, without however letting the respective address or addresses to be visible by the remaining message recipients. A field (“Subject” field) contains the message subject (if any) specified by the user. A field (“Orig-date” field) contains an indication of the date (and time) the message has been sent.

The MUA 315a communicates with an MTA 330a in the mail server 115a (to which the user ABC has subscribed for benefiting of the e-mail service). The MTA 330a communicates with other MTAs in other mail servers, such as an MTA 330b in the mail server 115b, and an MTA 330c in the mail server 115c depicted in FIG. 1, belonging to different domains.

According to an embodiment of the present invention, a distribution list builder agent 340 is provided in the mail server 115b (identified by the domain name bbb.com); for example, the distribution list builder agent 340 is associated with the MTA 330b, e.g. it may be a plug-in of the MTA 330b, which can be a per-se conventional MTA.

The distribution list builder agent 340 is adapted to interact with the directory server 310 managing the directory 305, so as to retrieve therefrom lists of e-mail addresses based on criteria set by the sender user ABC, as will be described in greater detail later on.

The MTAs 330b and 330c further communicates with MUAs of some of the intended message recipients, such as the MUAs 315b and 315d (for the MTA 330c), and the MUAs 315e and 315f (for the MTA 330b) running in the computers 105b and 105d, and 105e and 105f of the users DEF and JKL, and MNP and QRS.

The operation of the system depicted in FIG. 3 will be now described with the help of the schematic flowchart of FIG. 5. It is pointed out that although in the following the creation of a new message will be considered, this is merely an exemplary case, and actions similar to those described will be undertaken also in the case of, e.g., a “Reply” or “Reply to all” message.

The user ABC wishing to send an e-mail message to the intended recipients firstly launches, on his/her computer 105a, the e-mail managing client installed thereon, so as to activate the MUA 315a, and composes the new message (block 501). In order to compose the new e-mail message, the user may for example have to select a message compose command (e.g., a “New message” or “Create message” pushbutton on the GUI), which invokes the message composer software module.

In particular, according to an embodiment of the present invention, instead of specifying the e-mail addresses of the intended recipients (in the address fields “To”, “CC”, “Bcc” fields of the message composer dialog box), or in addition to doing this in respect of some of the intended recipients, for example in addition to including the addresses def@ccc.com and jkl@ccc.com of the users DEF and JKL, the user ABC puts in one of the address fields “To”, “Cc”, “Bcc”, e.g. in the “To” address field a “pseudo-address”, adapted to define one or more directives for searching through the directory 305 (block 503).

More particularly, in an embodiment of the present invention, the pseudo-address may include a “pseudo-username” part and a domain name part identifying the mail server whereat the distribution list builder agent 340 is present, in the example herein considered the domain name bbb.com of the mail server 115b. The pseudo-username instead is or includes an identifiable string, adapted to be identified by the (plug-in builder agent 340 of the) MTA 330b, defining one or more directory search directives. For example, in order to make the pseudo-username identifiable by the MTA 330b, a special character or set of characters may be defined, such as a square bracket “[” that must be the starting character of the pseudo-username string, or a pair of square brackets “[” and “]”, the former one placed for example at the beginning and the latter one at the end of the pseudo-username (just before the standard “@” separator).

Thus, the pseudo-address may for example take the form:
[list of directives] @bbb.com
   where list of directives stands for one or more directives adapted to be used by the builder agent 340 for building a distribution list.

It is pointed out that the way by which the pseudo-username is rendered identifiable, and in particular the number and type of special characters used, is merely application-dependant, and is not critical to the present invention. In particular embodiments, it may be necessary to avoid using characters that may coincide with identifiers of operators in the list of directives.

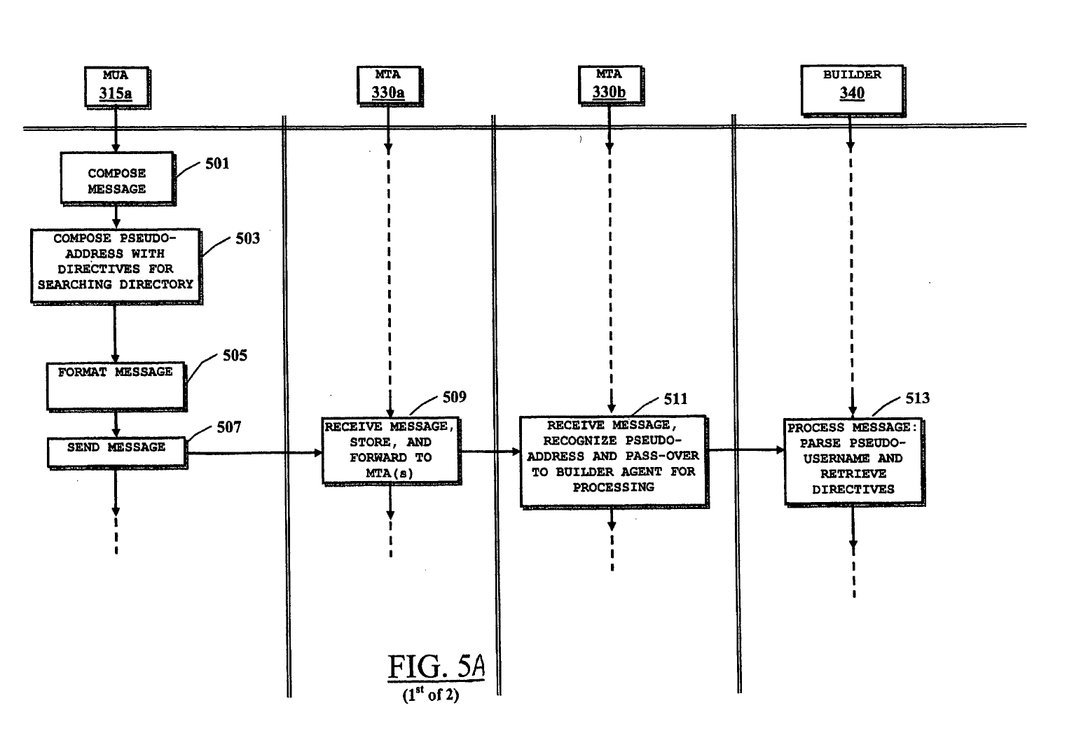

The directives' format may as well vary, and is per-se not critical to the present invention. For example, the directives may correspond to the standard LDAP attributes for a contact directory entry, as depicted in FIG. 4, and operators, such as logical operators (“AND”, “OR”, “NOT”, and the like) or arithmetic operators (“>”, “<”, etc.) may be used to combine two or more elementary directives. An exemplary directive may be:
dept=0666 AND manager=no
   (the corresponding pseudo-address is in this example [dept=0666 AND manager=no]@bbb.com) meaning for example that the directory 305 has to be searched for finding every contact that belongs to the department 0666 with the exception of the managers.

It is observed that, in an embodiment of the present invention, the sender user ABC has to manually enter the pseudo-address, and particularly the list of directives, in one of the address fields of the message being composed. Alternatively, a tool may be designed which assists the user in creating the list of directives, for example by means of one or more dialog boxes.

Once the user ABC has terminated composing the new message, by selecting a “Send” command (e.g., another pushbutton in the message composition window) the message is passed to the message formatter module of the MUA 315a, which formats the newly composed message according to the syntax prescriptions of one of the known standards for formatting e-mail messages (block 505).

The formatted message 320 includes, in one of the header address fields, the pseudo-address with the domain name bbb.com of the MTA 330b, and including as a pseudo-username the directives that the builder agent 340 will use for building the distribution list.

Adopting the above example, the resulting formatted message 320 can be represented as:

| Date: 31 Dec 04 2359 PDT | |
|---|---|
| From: <abc@aaa.com> | |
| Subject: Happy new year | |
| To: <def@ccc.com; jkl@ccc.com; [dept = 0666 AND manager = | |
| no]@bbb.com> | |
| Message-ID: | <OF6012DF61.14BFEF6C- |

NC1256C77.003DE64B@LocDomain>
plus message subject and message body (if any).

The pseudo-address [dept=0666 AND manager=no]@bbb.com> may be considered as representing, in a “compact” form, the desired distribution list.

The MUA 315a then sends the formatted message 320 to the MTA 330a in the mail server 115a (block 507).

The MTA 330a receives the message 320 from the MUA 315a and, as usually, it stores the message for subsequently forwarding it to the proper MTA(s), as specified by the domain name(s) in the e-mail address(es), in the example the MTA 330c, for the addresses def@ccc.com and jkl@ccc.com, and the MTA 330b (the MTA responsible of “expanding” the distribution list) for the address [dept=0666 AND manager=no]@bbb.com> (block 509). In particular, the MTA 330a contacts a domain name server 350 for resolving the specified domain name(s) and getting the MTAs' IP address(es).

A connection is established by the MTA 330a with the MTA 330c, and, as usual, one copy of the message is sent thereto, for the addresses def@ccc.com, jkl@ccc.com.

Similarly, a connection is established by the MTA 330a with the MTA 330b, and one copy of the message is sent thereto.

The message is received at the MTA 330b (block 509). Here, the (distribution list builder agent 340, which is a plug-in of the) MTA 330b recognizes the presence of the pseudo-address in one of the header address fields (for example, it recognizes the presence of the special characters “[” and “]”), and the MTA 330b passes over the message to the distribution list builder 340 for processing (block 511). In case the MTA 330b does not have associated therewith the distribution list builder plug-in 340, the message cannot be processed (the “compact” distribution list cannot be expanded), and an “undelivered message” notification will be sent back to the sender user ABC.

The distribution list builder 340 processes the message (block 513); in particular, the distribution list builder 340 parses the pseudo-username, identified by the special characters “[” and “]”, so as to retrieve the directives for building of the distribution list. The retrieved directives are then translated into a suitable language so as to become queries for the directory 305 (block 515); in particular, the query language (not limitative to the present invention) may be either X.500 compliant, or SQL, XML or other suitable query languages.

In particular, in the exemplary case the directory server 310 is an LDAP server, the query is preferably based on the standard LDAP search filter definition:

Filter ::= CHOICE {

| | |
|---|---|
| and | [0] SET OF Filter, |
| or | [1] SET OF Filter, |
| not | [2] Filter, |
| equalityMatch | [3] AttributeValueAssertion, |
| substrings | [4] SubstringFilter, |
| greaterOrEqual | [5] AttributeValueAssertion, |
| lessOrEqual | [6] AttributeValueAssertion, |
| present | [7] AttributeDescription, |
| approxMatch | [8] AttributeValueAssertion, |
| extensibleMatch | [9] MatchingRuleAssertion |

}

based on the following grammar:
filter = ″(″ filtercomp ″)″

| | |
|---|---|
| filtercomp | = and / or / not / item |
| and | = ″&″ filterlist |
| or | = ″\|″ filterlist |
| not | = ″!″ filter |
| filterlist | = 1*filter |
| item | = simple / present / substring / extensible |
| simple | = attr filtertype value |
| filtertype | = equal / approx / greater / less |
| equal | = ″=″ |
| approx | = ″˜=″ |
| greater | = ″>=″ |
| less | = ″<=″ |
| extensible | = attr [″:dn″] [″:″ matchingrule] ″:=″ |

value

| | / [″:dn″] ″:″ matchingrule ″:=″ value |
|---|---|
| present | = attr ″=*″ |
| substring | = attr ″=″ [initial] any [final] |
| initial | = value |
| any | = ″*″ *(value ″*″) |
| final | = value |

The distribution list builder agent 340 creates the distribution list via a look-up request to the directory 305. In particular, the distribution list builder 340 then contacts the directory server 310 and put the query/queries to the directory 305 (block 517). The directory server 310 receives the and submit them: the result of the query execution is a list 360 of e-mail addresses of intended e-mail message recipients, list that corresponds to the criteria specified by the sender user ABC; the directory server 310 sends the list of e-mail addresses to the distribution list builder 340 (block 519). The distribution list builder 340 receives the list 360 of e-mail addresses (block 521) and builds a distribution list (block 523), i.e., it “expands” the compact distribution list represented in compact form by the directives in the pseudo-username; for example, the distribution list includes the addresses mnp@bbb.com and qrs@bbb.com of the users MNP and QRS. The message is returned to MTA 330b for distribution (block 525); the MTA 330b receives the message to be propagated (block 527), and propagates the message to all the addresses in the distribution list (block 529), particularly to the users MNP and QRS, which can finally receive the message by their MUAs 315e, 315f (blocks 531, 533). In particular, the distribution list builder 340 places, in one of the recipient address header field “To”, “Cc”, “Bcc” of the message the addresses of the distribution list.

It is observed that according to a preferred embodiment of the present invention, the pseudo-address dept 0666 AND manager=no]@bbb.com> remains in the messages that are propagated by the MTA 330b to the users in the distribution list; in this way, the dynamic distribution list builder 340 can work as well in case one or more of the recipients reply to the received message: the reply message will in this case be sent back to the MTA 330b, which will pass the message over to the builder agent 340, so the distribution list process will be performed again.

Thanks to the described method and system, a non negligible reduction of data traffic over the data communications networks can be achieved. For example, if a sender user (whose computer is) located in, e.g., the United States of America needs to send an e-mail message to a group of persons located, for example, in Europe, a single e-mail message can in principle be transmitted from the MTA (in the United States) of the mail server serving the sender user to the MTA (located in Europe) where the distribution list will be created. Differently, if the sender user utilizes, as usual, a local distribution list, for example exploiting the address book utility of his/her e-mail client software, several messages will be created and sent, in principle one message for each intended recipient.

In other words, thanks to the described method and system it is possible to send an e-mail message intended for multiple recipients to a single MTA (identified by a domain name), without the need of knowing the recipients' addresses, and have the message expanded locally at the MTA receiver into a plurality of messages, for the different recipients.

Advantageously, the described method and system need no changes to the usual MUAs, so there is no impact on the users' computers side, and there is no need to deploy any new software or software update. It suffices to add a plug-in to an existing MTA.

Although the present invention has been described by way of an embodiment, it is apparent to those skilled in the art that several modifications to the described embodiments, as well as other embodiments of the present invention are possible without departing from the scope thereof as defined in the appended claims.

We claim:

1. In a data processing system supporting electronic mail (e-mail) messaging, a method of distributing an e-mail message from a sender mail user agent to mail user agents of recipients, comprising:
providing a remote directory of contact information of recipients including e-mail addresses of recipients, said remote directory being located remotely with respect to the sender mail user agent;
providing a mail transfer agent having an interface function with said remote directory, said interface function being adapted to interact with the remote directory so as to perform queries and obtain in reply lists of e-mail addresses of recipients;
including in an address field of the e-mail message a pseudo-address, said pseudo-address comprising an address of said mail transfer agent, and at least one directive for the interface function;
upon reception of the e-mail message by the mail transfer agent, having the interface function translate the at least one directive into a corresponding query, submitting the query to said directory, and retrieve a list of e-mail addresses of recipients; and
propagating the e-mail message from the mail transfer agent to the recipients whose e-mail addresses are in the list.

2. The method according to claim 1, in which said including in an address field of the e-mail message the pseudo-address comprises including in the address field an address having a domain-name portion corresponding to said mail transfer agent.

3. The method according to claim 2, in which said including in an address field of the e-mail message the pseudo-address comprises including in the address field an address having a pseudo-username portion identifiable by said interface function as carrying the at least one directive.

4. The method according to claim 3, comprising including in the pseudo-username portion at least one predefined character identifiable by the interface function as indicating the presence of the at least one directive.

5. The method according to claim 1, in which said propagating the e-mail message includes placing in at least one e-mail message address header field the addresses in the list, and retaining the pseudo-address.

6. The method according to claim 1, in which said directory is accessible through at least one directory server.

7. The method according to claim 1, in which said directory is compliant to the X.500 ITU-T recommendation.

8. The method according to claim 1, in which said directory is accessible using the LDAP protocol.

9. A data processing system supporting an electronic mail (e-mail) messaging service, comprising:
a sender mail user agent;
a remote directory of contacts of recipients including e-mail addresses of recipients, said remote directory being located remotely with respect to the sender mail user agent;
a mail transfer agent having an interface function with said remote directory, said interface function being adapted to interact with the directory so as to perform queries and obtain in reply list of e-mail addresses of recipients;
the interface function being adapted to:
identify an e-mail message received at the mail transfer agent and having, in an address field, a pseudo-address comprising an address of said mail transfer agent, and at least one directive for the interface function;
translate the at least one directive into a corresponding query;
submitting the query to said directory; and
retrieve a list of recipients e-mail addresses to which the e-mail message has to be propagated.

10. A computer program directly loadable in a working memory of a data processing apparatus and adapted to implement, when executed, the method according to claim 1.

11. A computer program product comprising the computer program of claim 10 stored in a computer readable media.

12. A method for sending e-mail to a plurality of recipients, comprising:
providing a directory of contact information of recipients including e-mail addresses of recipients, said directory being located remotely with respect to a sender mail user agent;
providing a mail transfer agent having an interface function with said directory, said interface function being adapted to interact with the directory so as to perform queries and obtain in reply lists of e-mail addresses of recipients, said mail transfer agent being responsive to an address field of an e-mail message containing a pseudo-address including an address of said mail transfer agent and at least one directive for the interface function;
upon reception of the e-mail message by the mail transfer agent, having the interface function translate the at least one directive into a corresponding query, submitting the query to said directory, and retrieve a list of e-mail addresses of recipients; and
propagating the e-mail message from the mail transfer agent to the recipients whose e-mail addresses are in the list.

13. The method according to claim 12, wherein said mail transfer agent is responsive to a pseudo-address comprises an address having a domain-name portion corresponding to said mail transfer agent.

14. The method according to claim 13, wherein said mail transfer agent is responsive to an address having a pseudo-username portion identifiable by said interface function as carrying the at least one directive.

15. The method according to claim 14, wherein said mail transfer agent is responsive to at least one predefined character, in the pseudo-username portion, identifiable by the interface function as indicating the presence of the at least one directive.

16. The method according to claim 12, in which said propagating the e-mail message includes placing in at least one e-mail message address header field the addresses in the list, and retaining the pseudo-address.

17. The method according to claim 12, further comprising providing at least one directory server through which said directory is accessible.

18. A data processing system supporting an electronic mail (e-mail) messaging service, comprising:
a directory of contacts of recipients including e-mail addresses of recipients, said directory being located remotely with respect to a sender mail user agent;
a mail transfer agent having an interface function with said directory, said interface function being adapted to interact with the directory so as to perform queries and obtain in reply list of e-mail addresses of recipients;
the interface function being configured to:
identify an e-mail message received at the mail transfer agent and having, in an address field, a pseudo-address comprising an address of said mail transfer agent, and at least one directive for the interface function;
translate the at least one directive into a corresponding query;
submitting the query to said directory; and
retrieve a list of recipients e-mail addresses to which the e-mail message is to be propagated.

19. A computer program directly loadable in a working memory of a data processing apparatus for implementing when executed, the data processing system according to claim 18.

20. The computer program of claim 19, having code which when executed includes, in an address field of the e-mail message an address having a domain-name portion corresponding to said mail transfer agent.
